(19) United States
(12) Patent Application Publication
(10) Pub. No.: US 2006/0266237 A1
(43) Pub. Date: Nov. 30, 2006

(54) Printing-material-carrying surface with micro-elevations, printing press cylinder and printing press having the surface and process having the surface and process for applying a fluid additive and printing process using the surface

(75) Inventors: Karl-Heinz Helmstadter, Heidelberg (DE); Lars Chr. Herzbach, Munchen-Freimann (DE); Hans-Peter Hiltwein, Waghausel (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/432,360

(22) Filed: May 11, 2006

(30) Foreign Application Priority Data
May 31, 2005 (DE) 10 2005 024 726.1

(51) Int. Cl. B41F 5/00

(52) U.S. Cl. 101/216

(57) ABSTRACT

A printing-material-carrying surface, having micro-elevations which make contact with a printing material provided with printing ink, is at least partly provided, preferably substantially only at peaks of the micro-elevations, with a fluid additive to improve print quality, in particular in recto and verso printing. The fluid additive, in particular a liquid additive diluting the printing ink and/or delaying and/or slowing the drying of the printing ink, is at least partly transferred to the printing material by the surface. A printing press cylinder and a printing press having the printing-material-carrying surface and a process for applying a fluid additive and a printing process using the printing-material-carrying surface, are also provided.

### BACKGROUND OF THE INVENTION

### Field of the Invention

The present invention relates to a printing-material-carrying surface having micro-elevations which make contact with a printing material provided with printing ink. The invention also relates to a printing press cylinder and a printing press having the printing-material-carrying surface and a process for applying a fluid additive and a printing process using the printing-material-carrying surface.

In recto and verso printing, that is to say printing both sides of printing material in one pass through a printing press, after the printing material has been turned, the printing material comes to lie with an already printed and possibly not yet sufficiently dried side on the respective surface of the impression cylinders of the verso printing units. The printing material is pressed under pressure against the respective surfaces of the impression cylinders as it passes through the nips of the verso printing units of the printing press. In order to avoid ink being picked up by the surface of the impression cylinder, soiling of the surface and ink splitting or separating back onto the following printing materials, the surface is normally structured and, as a result, its loadbearing proportion is reduced and/or provided with an ink-repellent coating.

German Published, Non-Prosecuted Patent Application DE 42 07 119 A1, corresponding to UK Patent Application GB 2 264 766 A, describes a sheet-carrying circumferential profile of the impression cylinder for impression cylinders in sheet-fed printing presses for recto and verso printing. In that case, the circumferential profile of the impression cylinder is formed of cylindrical elevations which are distributed statistically uniformly, form the impression cylinder surface and are disposed plane-parallel with the impression cylinder axis and perpendicular to the circumferential surface of the impression cylinder. In that case, the circumferential profile of the impression cylinder can be etched into a chrome coating of the impression cylinder. Coating of the circumferential profile of the impression cylinder or wetting with a liquid is not provided.

German Published, Non-Prosecuted Patent Application DE 102 09 297 A1 describes a surface for sheet-carrying cylinders which come into contact with printing ink and can be soiled in the process. In that case, a loadbearing layer of the surface has pores, into the interior of which a single-layer or multilayer functional coating reaches. The functional coating, which is applied in liquid form, penetrates into the pores before it is cured through the use of drying and subsequent thermal post-treatment. Additional wetting of the surface with a liquid is not provided.

German Published, Non-Prosecuted Patent Application DE 195 15 393 B4, corresponding to U.S. Pat. No. 5,797,827, describes a printing-material-carrying surface structure for printing press cylinders or their covers, preferably in recto and verso printing, having approximately uniformly statistically distributed elevated structural elements and associated structural valleys, with the printing material being supported on the structural elements. In that case, the structural elements themselves are configured with a large number of depressions forming an irregular network of gaps, furrows and cracks, so that each loadbearing surface of a structural element is formed from a large number of smaller surfaces, in order to reduce the adhesive force of the printing ink. Coating of the surface structure or wetting with a liquid is not provided.

German Published, Non-Prosecuted Patent Application DE 21 27 021, corresponding to U.S. Pat. No. 3,686,771, describes impression cylinders which follow a turning device and have a respective surface which is provided with an ink-repellent layer. In that case, the ink-repellent layer proposed is a film of moisture, which is deposited on the surface of the impression cylinder from moist air that is supplied. Structuring of the surface of the impression cylinder, in particular micro-structuring, is not provided.

European Patent EP 0 873 867 B1, corresponding to U.S. Pat. No. 6,143,074, describes a recto printing press in which an application of varnish to the opposite side of a sheet printed in the recto printing process is carried out over the entire area or in sections over the surface of a varnishing cylinder-impression cylinder. Since a recto printing press is described, the problem of the deposition of ink on the surface of the varnishing cylinder-impression cylinder does not exist and, accordingly, no countermeasures in that respect are provided either.

German Published, Non-Prosecuted Patent Application DE 102 27 758 A1 describes a sheet-fed rotary printing press having a coating unit which applies a highly ink-repellent coating liquid to the surface of an impression cylinder. The coating liquid is fixed through the use of drying and, in the fixed state, forms a firm, ink-repellent and/or wear-inhibiting layer. In the event of wear of the coating, repeated coating can be carried out through the use of the coating unit. However, a structured, in particular micro-structured, surface of the impression cylinder is not provided. Additional wetting of the surface with a liquid is not provided either.

German Published, Non-Prosecuted Patent Application DE 197 16 424 A1 describes a cylinder disposed after a turning device and having a circumferential surface which has a firm silicone rubber layer which is formed as a continuous, uninterrupted surface. The deposition of ink on the surface of the cylinder is avoided through the use of the silicone rubber layer. Structuring, in particular micro-structuring, of the surface of the cylinder or the layer applied is not provided, nor is wetting with a liquid.

Since even the prior art devices and methods do not always ensure a satisfactory print quality and, in particular, the aim is to prevent the production of what are known as “white dots” (see FIG. 3 and the associated description), there is no change in the desire for an improved printing-material-carrying surface.

### SUMMARY OF THE INVENTION

It is accordingly an object of the invention to provide a printing-material-carrying surface with micro-elevations, a printing press cylinder and a printing press having the surface and a process for applying a fluid additive and a printing process using the surface, which overcome the hereinafore-mentioned disadvantages of the heretofore-known devices and processes of this general type and which permit an increase in printed image quality. It is a further or alternative object of the present invention to provide a printing-material-carrying surface which prevents the production of “white dots”. It is an additional object of the present invention to provide a printing process which makes it possible to bring about an increase in the printed image quality and which, in particular, makes it possible to counteract the production of “white dots”.

With the foregoing and other objects in view there is provided, in accordance with the invention, a printing-material-carrying surface. The surface comprises micro-elevations making contact with a printing material provided with printing ink. A fluid additive is provided at least at part of the micro-elevations.

According to the invention, firstly micro-elevations and secondly a fluid additive are provided. This advantageously leads to an increase in the printed image quality and, in particular, to the prevention of the production of “white dots”. The “white dots” produced by the micro-elevations are closed again by the fluid additive or by the action of the fluid additive and are therefore invisible to the eye in the printed image. The interaction of the micro-elevations and the fluid additive thus leads to the surprising result that, despite the provision of micro-elevations, “white dots” can be avoided.

Due to the provision of micro-elevations, firstly the loadbearing proportion of the surface is reduced and secondly a micro-roughness is created which is useful when carrying the printing materials, in particular in preventing relative movements with respect to the surface. The micro-elevations which make contact with the printing material can also penetrate into the printing material or penetrate through the printing material and, consequently, produce a form-locking connection. As a result, the printing material is guided better and a relative movement with respect to the surface, which can lead to damage to the image being printed on, is better prevented. A form-locking connection is one which connects two elements together due to the shape of the elements themselves, as opposed to a force-locking connection, which locks the elements together by force external to the elements.

The provision of the fluid additive on the surface advantageously leads to coalescence of the printing ink being promoted at those points at which “white dots” would be produced if the invention were not used. In other words, the fluid additive is transferred to the printing material, at least at the contact points of the micro-elevations with the printing material, and there leads to the “white dots” being closed.

The fluid additive can be applied or can have been applied in the fluid state and preferably remains on the surface in the fluid state, that is to say this is preferably an additive which does not harden on the surface. For example, a liquid is applied and this remains on the surface in the liquid state, in which it also reaches the printing material. In other words, the liquid additive remains liquid at least from the application to the surface until the transfer to the printing material.

In accordance with another feature of the invention, which is optimized with regard to the increase in the printed image quality, substantially only peaks of the micro-elevations are provided with the fluid additive. In this way, the fluid additive specifically reaches those points of the printing material which, without the use of the invention, could form “white dots”. Furthermore, the situation is advantageously avoided in which more fluid additive than is absolutely necessary to avoid “white dots” reaches the recto printing side of the printing material. In this way, a further increase in the printed image quality can be achieved.

In accordance with a further feature of the invention, which is optimized with regard to the increase in the printed image quality, at least a number of the peaks have at least one respective depression. The respective depression is formed as a reservoir which holds the fluid additive, that is to say stores it, at least in the short term, and discharges it at least partly to the printing material. As a result of the provision of depressions, the application and holding or storage of the fluid additive on the peaks of the micro-elevations can be improved further and, moreover, the specific transfer of the fluid additive in the desired quantity to the recto printing side of the printing material can be achieved.

In accordance with an added feature of the invention, the fluid additive can be a liquid additive, in particular an additive different from printing ink, varnish or dampening solution, which dilutes the printing ink and/or delays and/or slows the drying of the printing ink. A fluid additive that is used according to the invention, which has the described effects with regard to dilution or drying of printing ink, advantageously supports the coalescence of printing ink and thus the prevention of the production and/or the closing of “white dots”.

In accordance with an additional feature of the invention, which is optimized with regard to the increase in the printed image quality, the surface is at least partly provided, in particular between the micro-elevations, with an ink-repellent coating. As a result of the provision of the ink-repellent coating according to the invention, it is advantageously possible to prevent printing ink from the recto printing side of the printing material from being deposited on the surface and leading to a reduction in the printed image quality as a result of splitting back onto following printing materials. Furthermore, an ink-repellent coating between the micro-elevations assists the specific application of a fluid additive only in the region of the peaks of the micro-elevations, provided that the fluid additive has properties similar to ink, so that the application of the fluid additive only in the region of the peaks is simplified.

With the objects of the invention in view, there is also provided a printing press cylinder, in particular an impression cylinder, comprising a printing-material-carrying surface according to the invention.

With the objects of the invention in view, there is additionally provided a printing press, in particular a sheet-fed offset printing press for recto and verso printing, comprising a printing-material-carrying surface according to the invention.

With the objects of the invention in view, there is furthermore provided a process for applying a fluid additive to printing material. The process comprises providing a printing-material-carrying surface having cracked or porous micro-elevations making contact with the printing material provided with printing ink. The fluid additive is applied to the printing material with the printing-material-carrying surface.

In this case, the cracks or pores in the micro-elevations can advantageously serve as reservoirs for the fluid additive and thus assist a specific transfer of the fluid additive in a desired quantity to the recto printing side of the printing material.

With the objects of the invention in view, there is also provided a printing process. The process comprises making contact between a side of a printing material provided with printing ink, and a surface having micro-elevations. A fluid additive is applied to the surface.

The printing process according to the invention incorporates advantages as described above with reference to a printing-material-carrying surface according to the invention.

In accordance with a concomitant mode of the invention, the fluid additive is applied substantially only to peaks of the micro-elevations, which means that, in turn, the specific transfer of the fluid additive to the printing material only at the problematic contact points of the surface is made possible.

Other features which are considered as characteristic for the invention are set forth in the appended claims.

Although the invention is illustrated and described herein as embodied in a printing-material-carrying surface with micro-elevations, a printing press cylinder and a printing press having the surface and a process for applying a fluid additive and a printing process using the surface, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a printing press according to the invention;

FIG. 2 is an enlarged plan view of a printing-material-carrying surface according to the invention;

FIG. 3 is an enlarged plan view of a full-tone area with “white dots”;

FIG. 4 is a further enlarged, fragmentary, sectional view of a portion A of the printing-material-carrying surface according to the invention shown in FIG. 2;

FIG. 5 is a view similar to FIG. 4 of a further embodiment of the printing-material-carrying surface according to the invention; and

FIG. 6 is a view similar to FIG. 1 of a further embodiment of a printing press according to the invention.

### DESCRIPTION OF THE PREFERRED EMBODIMENTS

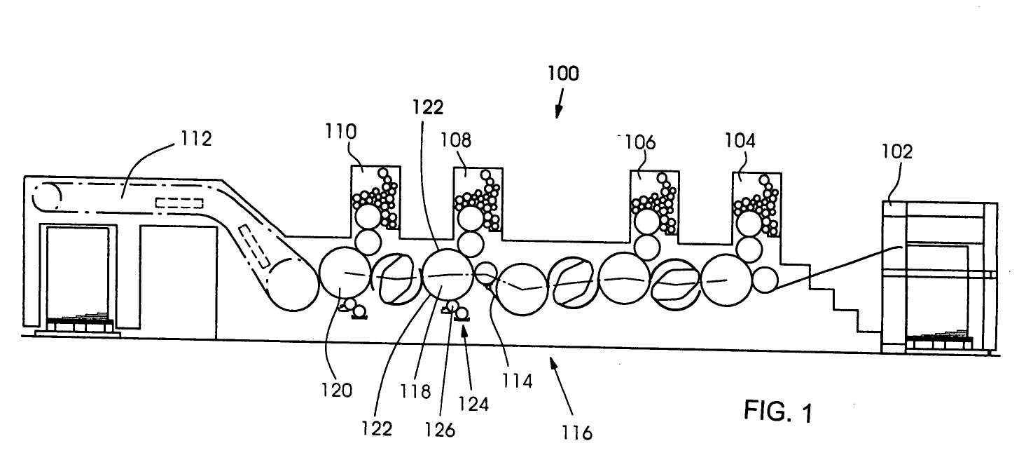

Referring now to the figures of the drawings in detail and first, particularly, to FIG. 1 thereof, there is seen a sheet-fed offset printing press 100 having a sheet feeder 102, four offset printing units 104, 106, 108 and 110 and a sheet delivery 112. The printing press 100 can be operated in the recto and verso printing mode, that is to say the first two printing units 104 and 106 print the first side of a printing material sheet 114, and the two further printing units 108 and 110 print the second side of the printing material 114. For this purpose, the printing material 114 is turned by a turning device 116.

The printing material 114 comes to lie with the already printed first side on two impression cylinders 118 and 120 disposed after the turning device 116, and runs under pressure through a respective printing press nip of the printing units 108 and 110. In order to prevent the deposition of ink and the build-up of ink on respective printing-material-carrying surfaces of the impression cylinders 118 and 120, and in order to prevent a relative movement between the printing material 114 and the respective printing-material-carrying surface of the impression cylinders, these cylinders are provided with a micro-rough and ink-repellent surface 122. This surface 122 can preferably be formed by one or more respective cylinder covers.

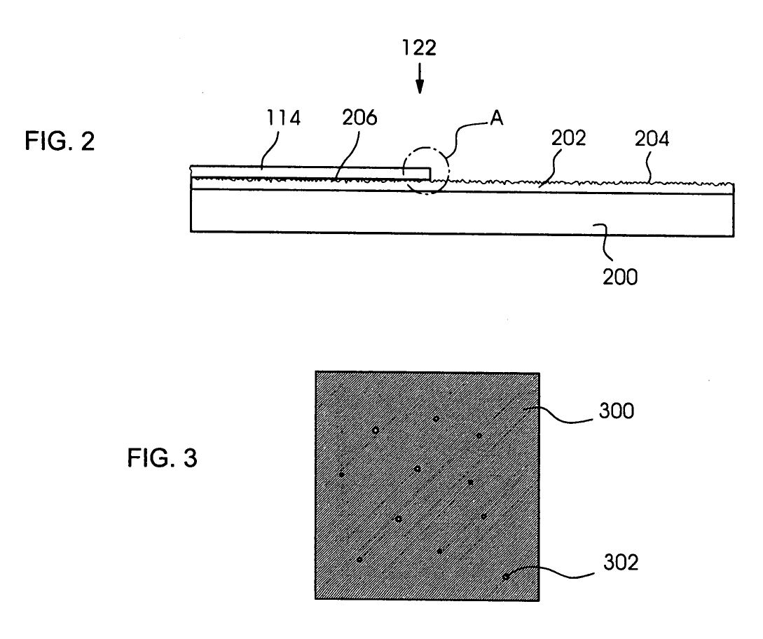

A printing-material-carrying surface 122 is shown in FIG. 2. This surface 122 includes a carrier 200, for example of rust-free steel sheet with a thickness from about 0.24 mm to about 0.27 mm, having a micro-rough coating 202 with a micro-structure, for example a plasma-sprayed oxide ceramic layer, in particular of aluminum or titanium. The micro-rough coating 202 is provided with an ink-repellent coating 204, for example a silicone, at least in depressions of the micro-rough coating 202.

During transport, that is to say during rotation of the impression cylinders 118 and 120, the printing material 114 is guided by the printing-material-carrying surface 122. In the process, micro-elevations 206 prevent a relative movement between the printing material sheet 114 and the printing-material-carrying surface 122, and thus prevent damage to the recto-printing printed image.

FIG. 3 shows an enlarged illustration of a full-tone area 300 of a printed product, in which small, light spots 302 can be seen, which disrupt the printed image and can impair the printing quality. The light spots 302 (the “white dots”) are produced by contact of the micro-elevations 206 with the printing material 114, with ink separating from the printing material 114 at the contact points. The light spots 302, which have no ink or less ink than the surrounding region, are thus produced at the contact points of the printing material 114 with the micro-rough surface 122.

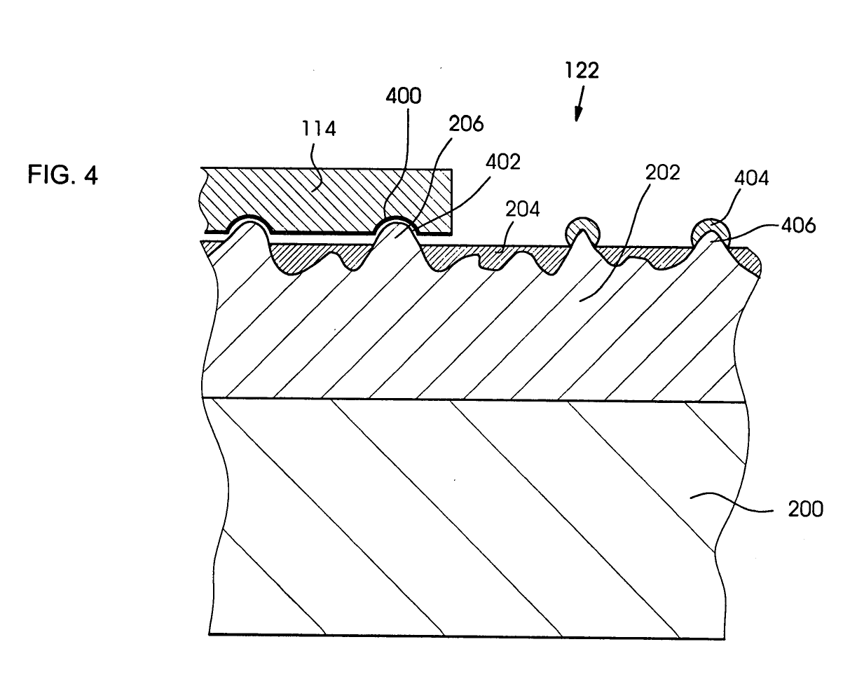

A portion A of FIG. 2 is illustrated in enlarged form in FIG. 4. The micro-rough coating 202 is applied to the carrier 200. The thickness of this micro-rough coating preferably lies in a range between about 40 μm and 70 μm. The micro-rough coating has micro-elevations which, on average, have a height in a range from about 5 μm to about 30 μm. The roughness of the micro-rough coating (that is to say the RZ value) preferably lies in a range from about 20 μm to about 40 μm. The diameter of the micro-elevations preferably lies in a range from about 10 μm to about 50 μm.

In FIG. 4 it can be seen how the micro-elevations 206 press into the printing material 114 provided with printing ink 400 and cause depressions 402 to be produced which, after the printing material 114 has been removed from the surface 122, lead to the light spots 302, the “white dots”, in the recto-printing printed image.

The ink-repellent coating 204 on the micro-rough coating 202 prevents the ink from being picked up by the printing-material-carrying surface 122, at least in the region between the micro-elevations 206. In this case, micro-elevations of low height can be covered by the ink-repellent coating 204.

In order to prevent damage to the recto-printing printed image, in particular in order to prevent the production of the light spots 302, the invention provides for the printing-material-carrying surface 122 to be provided at least partly with a fluid additive 404, for example for it to be wetted by rolling on or spraying.

As is illustrated in FIG. 1, in order to apply the fluid additive 404 to the printing-material-carrying surface 122, use is made of an application device 124, which applies the fluid additive 404 to the printing-material-carrying surface 122 in the desired quantity and at the desired locations. The application device 124 can include an applicator roll 126, as illustrated. The application can be carried out continuously or cyclically, preferably before each printing material sheet, before the latter comes to lie on the printing-material-carrying surface 122. Furthermore, the applicator roll 126 can be doctored off or cleaned. Alternatively, for example, a spraying device activated continuously or cyclically can also be provided.

The fluid additive 404 can, for example, be an ink-diluting liquid and/or a liquid delaying and/or slowing the ink drying. Alternatively, it can also be a printing ink.

A liquid which is normally used to reduce the tack of printing inks (e.g. the product Paste 900 from the company Gebr. Schmidt Druckfarben) or a printing oil is, for example, suitable as an ink-diluting liquid. Oils or oleophobic liquids are, for example, suitable as the liquid delaying and/or slowing the ink drying.

According to the invention, the fluid additive 404 reaches the surface of the printing material 114 as a result of transfer from the printing-material-carrying surface 122, at least at the contact locations of the micro-elevations 206, and advantageously prevents the production of light spots 302. As a result of the ink-diluting action and/or the action of the fluid additive 404 slowing and/or delaying the ink drying, the contact points fill with printing ink again during or following the separation of the sheet 114 from the printing-material-carrying surface 122 and before the drying of the printing ink 400, and thus the production of light spots 302 can be prevented effectively. In other words, the light spots 302 are closed again as a result of coalescence of the printing ink that has been diluted or changed with regard to its ink drying.

When a resilient applicator roll 124 is used, through the use of a suitable setting of the pressure in relation to the impression cylinder 118 or 120, it is possible for the fluid additive 404 to wet only the peaks 406 (contact locations or contact areas) of the micro-elevations 206 and, in this way, be brought specifically to the contact points of the micro-elevations 206 with the printing material 114. Provided the fluid additive 404 has a composition similar to ink, it will not be picked up by the ink-repellent coating 204, which promotes the specific wetting of the micro-elevations 206.

The pressure is preferably chosen such that the micro-elevations press substantially as far into the resilient surface of the applicator roll 124 as they also press into the printing material during the printing operation.

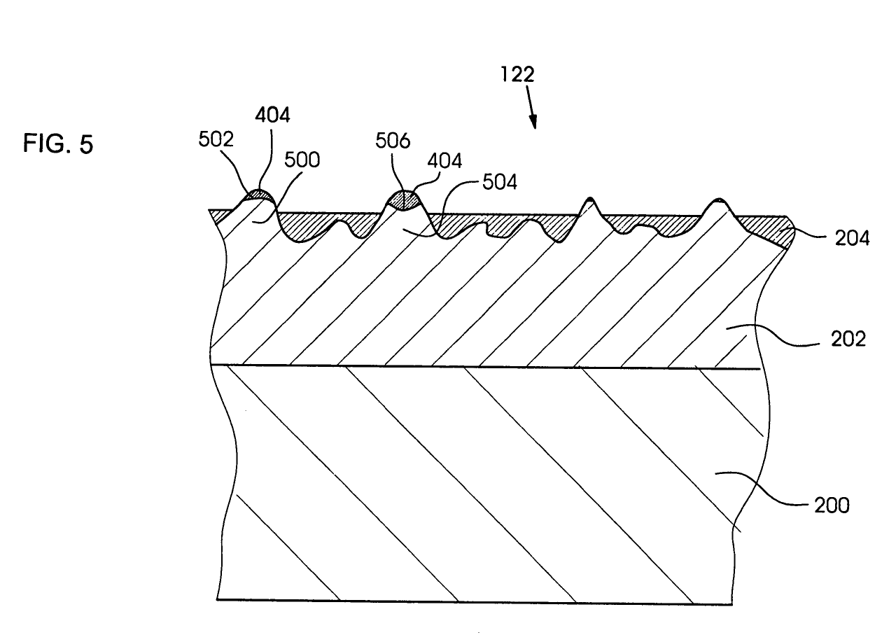

A further embodiment of the printing-material-carrying surface 122 is shown in FIG. 5, in which the peaks of the micro-elevations are removed or formed as depressions. A micro-elevation 500 has a peak that has been removed and thus a substantially flat contact area 502, which is provided with the fluid additive 404. The micro-elevation 504 has, by contrast, a depression 506 in the region of the peak, which is provided with the fluid additive 404 and which, to a certain extent, is formed as a reservoir for the fluid additive 404. The depression can be provided as a crack or cracks or pores produced in the region of the peak of the micro-elevation 504 in the manufacturing process.

Alternatively, the depression 506 can also be introduced into the micro-elevation 504. For this purpose, the printing-material-carrying surface 122 can be pressed onto a likewise micro-rough opposing surface but which has a greater number of micro-elevations per unit area and a greater hardness, so that the micro-elevations of the opposing surface are molded into the micro-elevations of the printing-material-carrying surface 122.

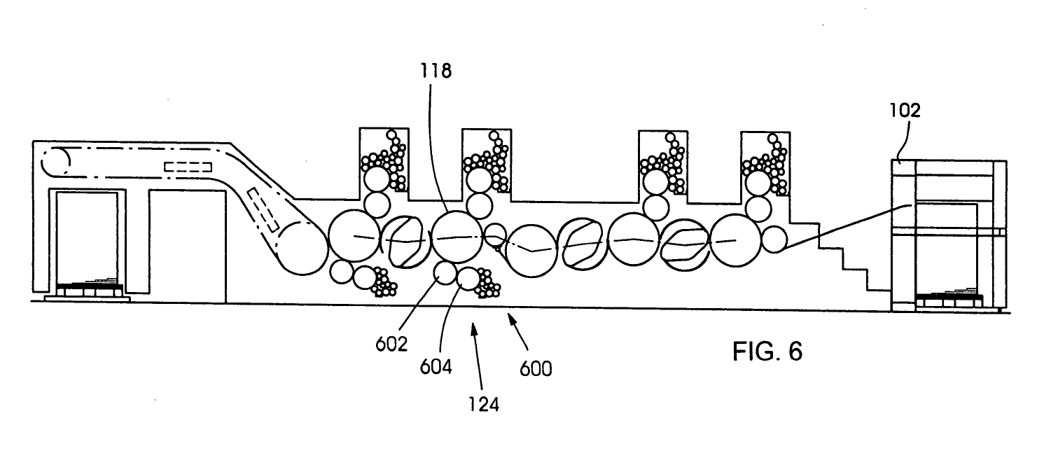

An embodiment of a printing press according to the invention that is an alternative to FIG. 1 is shown in FIG. 6. The application device 124 in this embodiment includes a preferably simple inking and dampening unit 600 as well as a blanket cylinder 602 and a form cylinder 604. Such an application device can effect both a full-area application, a partial-area application (e.g. only in the region of full-tone areas) of ink and even an application of ink in accordance with an image. An application of ink can be achieved only in the region of the peaks of the micro-elevations of the printing-material-carrying surface of the impression cylinder through the pressure between the blanket cylinder 602 and the impression cylinder 118. The application device 124 can apply one ink and, when a plurality of inking units and form cylinders are used, a plurality of inks.

We claim:

1. A printing-material-carrying surface, comprising:
micro-elevations making contact with a printing material provided with printing ink; and
a fluid additive provided at least at part of said micro-elevations.

2. The printing-material-carrying surface according to claim 1, wherein said micro-elevations have peaks, and substantially only said peaks are provided with said fluid additive.

3. The printing-material-carrying surface according to claim 1, wherein said micro-elevations have peaks, and at least a number of said peaks have at least one respective depression formed as a reservoir holding said fluid additive.

4. The printing-material-carrying surface according to claim 1, wherein said fluid additive is a liquid additive.

5. The printing-material-carrying surface according to claim 4, wherein said liquid additive is different from printing ink, varnish or dampening solution, and said liquid additive at least one of dilutes the printing ink, delays drying of the printing ink or slows drying of the printing ink.

6. The printing-material-carrying surface according to claim 1, which further comprises an ink-repellent coating.

7. The printing-material-carrying surface according to claim 6, wherein said ink-repellent coating is provided between said micro-elevations.

8. A printing press cylinder, comprising a printing-material-carrying surface according to claim 1.

9. A printing press impression cylinder, comprising a printing-material-carrying surface according to claim 1.

10. A printing press, comprising a printing-material-carrying surface according to claim 1.

11. A sheet-fed offset printing press for recto and verso printing, comprising a printing-material-carrying surface according to claim 1.

12. A process for applying a fluid additive to printing material, which comprises the following steps:
providing a printing-material-carrying surface having cracked or porous micro-elevations making contact with the printing material provided with printing ink; and
applying the fluid additive to the printing material with the printing-material-carrying surface.

13. A printing process, which comprises the following steps:
making contact between a side of a printing material provided with printing ink, and a surface having micro-elevations; and
applying a fluid additive to the surface.

14. The printing process according to claim 13, which further comprises applying the fluid additive substantially only to peaks of the micro-elevations.
